(19) United States
(12) Patent Application Publication
(10) Pub. No.: US 2012/0117335 A1
(43) Pub. Date: May 10, 2012

(54) LOAD ORDERING QUEUE

(75) Inventor: Christopher D. Bryant, Austin, TX (US)

(73) Assignee: ADVANCED MICRO DEVICES, INC.

(21) Appl. No.: 12/943,641

(22) Filed: Nov. 10, 2010

(51) Int. Cl. G06F 12/00; G06F 12/08

(52) U.S. Cl. 711/146; 711/158; 711/E12.001; 711/E12.017

(57) ABSTRACT

A method and apparatus to utilize a strong ordering scheme to be performed on memory operations in a processor to prevent performance degradation caused by out-of-order memory operations is provided. Also provided is a computer readable storage device encoded with data for adapting a manufacturing facility to create an apparatus. The method includes storing information associated with a first load operation in a load queue, the first load operation being executed out-of-order with respect to one or more second load operations. The method also includes detecting a snoop hit on the first load operation. The method further includes re-executing the first load operation in response to detecting the snoop hit.

### BACKGROUND OF THE INVENTION

1. Field of the Invention

Embodiments of this invention relate generally to computers, and, more particularly, to the processing and maintenance of out-of-order memory operations.

2. Description of Related Art

Processors generally use memory operations to move data to and from memory. The term “memory operation” refers to an operation that specifies a transfer of data between a processor and memory (or cache). Load memory operations specify a transfer of data memory to the processor, and store memory operations specify a transfer of data from the processor to memory.

Some instruction set architectures require strong ordering of memory operations (e.g., the x86 instruction set architecture). Generally, memory operations are strongly ordered if they appear to have occurred in the program order specified. Processors often attempt to perform load operations out of program order to improve performance. However, if the load operation is performed out of order, it is possible to violate strong memory ordering rules.

For example, if a first processor performs a store to address A1 followed by a store to address A2, and a second processor performs a load from address A2 (which misses in the data cache of the second processor) followed by a load from address A1 (which hits in the data cache of the second processor, strong memory ordering rules may be violated. Strong memory ordering rules require, in the above example, that if the load from address A2 receives the store data from the store to address A2, then the load from address A1 must receive the store data from the store to address A1. However, if the load from address A1 is allowed to complete while the load from address A2 is being serviced, then the following scenario may occur: first the load from address A1 may receive data prior to the store to address A1; second the store to address A1 may complete; third the store to address A2 may complete; and fourth the load from address A2 may complete and receive the data provided by the store to address A2. This outcome would be incorrect because the load from address A1 occurred before the store to address A1. In other words, the load from address A1 will receive stale data.

### SUMMARY OF EMBODIMENTS OF THE INVENTION

In one aspect of the present invention, a method is provided. The method includes storing information associated with a first load operation in a load queue, the first load operation being executed out-of-order with respect to one or more second load operations. The method also includes detecting a snoop hit on the first load operation. The method further includes re-executing the first load operation in response to detecting the snoop hit.

In another aspect of the present invention, an apparatus is provided. The apparatus includes a load queue for storing information associated with a first load operation, the first load operation being executed out-of-order with respect to one or more second load operations and a processor. The processor is configured to store the information associated with the first load operation in the load queue. The processor is also configured to detect a snoop hit on the first load operation stored in the load queue. The processor is further configured to re-execute the first load operation stored in the load queue in response to detecting the snoop hit.

In yet another aspect of the present invention, a computer readable storage medium encoded with data that, when implemented in a manufacturing facility, adapts the manufacturing facility to create an apparatus, is provided. The apparatus includes a load queue for storing information associated with a first load operation, the first load operation being executed out-of-order with respect to at or more second load operations and a processor. The processor is configured to store the information associated with the first load operation in the load queue. The processor is also configured to detect a snoop hit on the first load operation stored in the load queue. The processor is further configured to re-execute the first load operation stored in the load queue in response to detecting the snoop hit

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a simplified block diagram of a computer system according to one embodiment;

FIG. 2 shows a simplified block diagram of multiple computer systems connected via a network according to one embodiment;

FIG. 3 illustrates an exemplary detailed representation of one embodiment of the central processing unit provided in FIGS. 1-2 according to one embodiment;

FIG. 4 illustrates an exemplary detailed representation of one embodiment of a load/store unit coupled to a data cache and a translation lookaside buffer according to one embodiment of the present invention;

FIG. 5 illustrates a flowchart for operations of the load/store unit during execution of an out-of-order load according to one embodiment of the present invention; and

FIG. 6 illustrates a flowchart for operations of the load/store unit during execution of a snoop operation according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

The present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments of the present invention generally provide a strong ordering scheme to be performed on memory operations in a processor to prevent performance degradation caused by out-of-order memory operations.

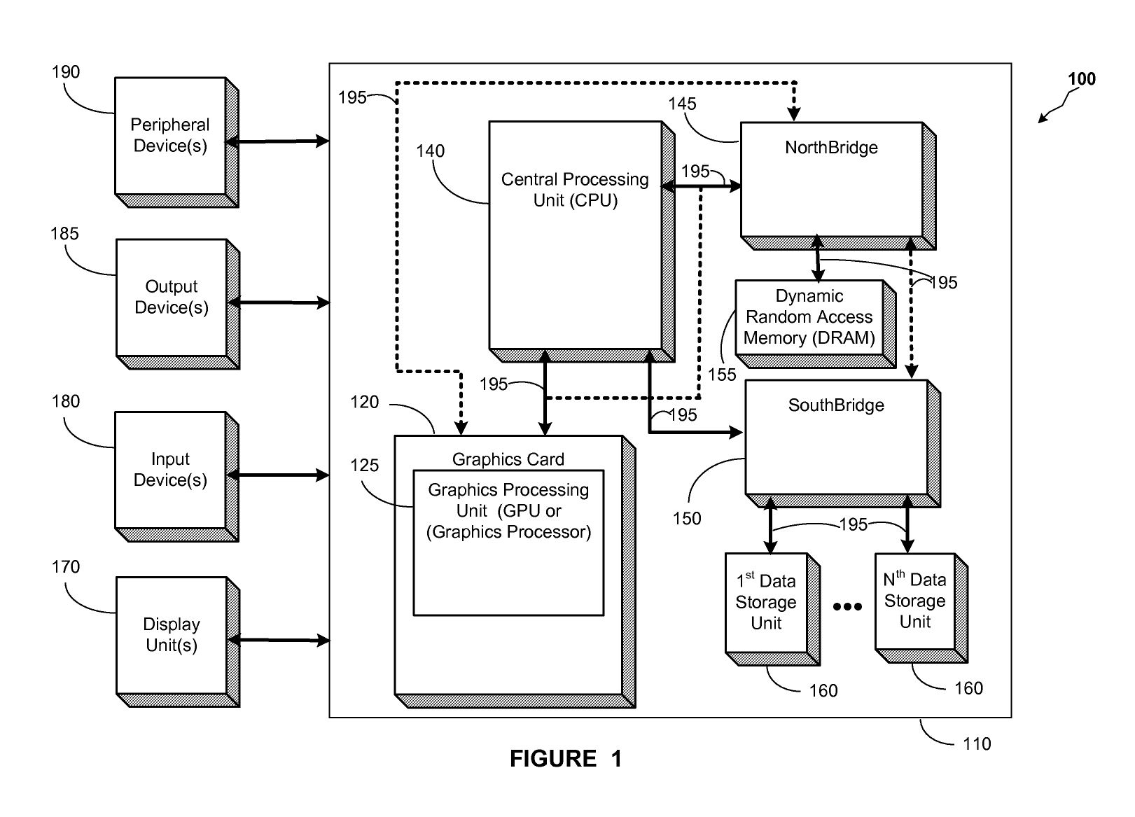

Turning now to FIG. 1, a block diagram of an exemplary computer system 100, in accordance with an embodiment of the present invention, is illustrated. In various embodiments the computer system 100 may be a personal computer, a laptop computer, a handheld computer, a netbook computer, a mobile device, a telephone, a personal data assistant (PDA), a server, a mainframe, a work terminal, or the like. The computer system includes a main structure 110, which may be a computer motherboard, system-on-a-chip, circuit board or printed circuit board, a desktop computer enclosure and/or tower, a laptop computer base, a server enclosure, part of a mobile device, personal data assistant (PDA), or the like. In one embodiment, the main structure 110 includes a graphics card 120. In one embodiment, the graphics card 120 may be an ATI Radeon™ graphics card from Advanced Micro Devices (“AMD”) or any other graphics card using memory, in alternate embodiments. The graphics card 120 may, in different embodiments, be connected on a Peripheral Component Interconnect (PCI) Bus (not shown), PCI-Express Bus (not shown) an Accelerated Graphics Port (AGP) Bus (also not shown), or any other connection known in the art. It should be noted that embodiments of the present invention are not limited by the connectivity of the graphics card 120 to the main computer structure 110. In one embodiment, the computer system 100 runs an operating system such as Linux, Unix, Windows, Mac OS, or the like.

In one embodiment, the graphics card 120 may contain a graphics processing unit (GPU) 125 used in processing graphics data. In various embodiments the graphics card 120 may be referred to as a circuit board or a printed circuit board or a daughter card or the like.

In one embodiment, the computer system 100 includes a central processing unit (CPU) 140, which is connected to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other connection as is known in the art. For example, the CPU 140, the northbridge 145, and the GPU 125 may be included in a single package or as part of a single die or “chips”. Alternative embodiments, which may alter the arrangement of various components illustrated as forming part of main structure 110, are also contemplated. In certain embodiments, the northbridge 145 may be coupled to a system RAM (or DRAM) 155; in other embodiments, the system RAM 155 may be coupled directly to the CPU 140. The system RAM 155 may be of any RAM type known in the art; the type of RAM 155 does not limit the embodiments of the present invention. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125, and/or DRAM 155 may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

In different embodiments, the computer system 100 may be connected to one or more display units 170, input devices 180, output devices 185, and/or peripheral devices 190. It is contemplated that in various embodiments, these elements may be internal or external to the computer system 100, and may be wired or wirelessly connected, without affecting the scope of the embodiments of the present invention. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier or other output device. The peripheral devices 190 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like. To the extent certain exemplary aspects of the computer system 100 are not described herein, such exemplary aspects may or may not be included in various embodiments without limiting the spirit and scope of the embodiments of the present invention as would be understood by one of skill in the art.

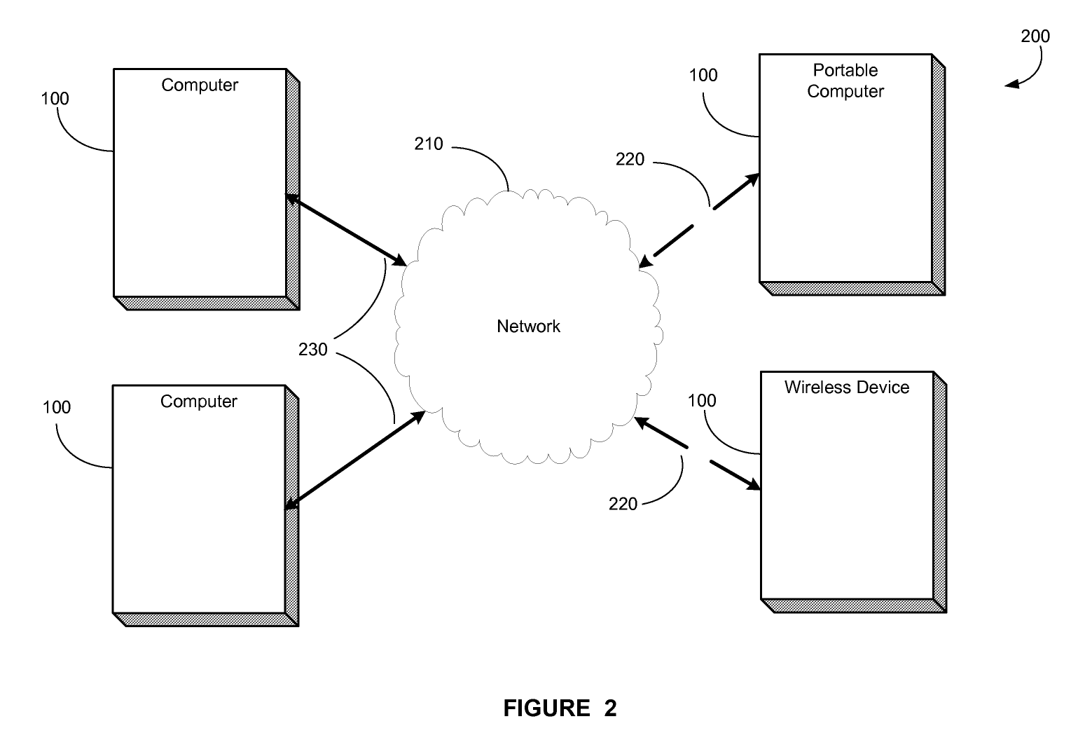

Turning now to FIG. 2, a block diagram of an exemplary computer network 200, in accordance with an embodiment of the present invention, is illustrated. In one embodiment, any number of computer systems 100 may be communicatively coupled and/or connected to each other through a network infrastructure 210. In various embodiments, such connections may be wired 230 or wireless 220 without limiting the scope of the embodiments described herein. The network 200 may be a local area network (LAN), wide area network (WAN), personal network, company intranet or company network, the Internet, or the like. In one embodiment, the computer systems 100 connected to the network 200 via network infrastructure 210 may be a personal computer, a laptop computer, a netbook computer, a handheld computer, a mobile device, a telephone, a personal data assistant (PDA), a server, a mainframe, a work terminal, or the like. The number of computers depicted in FIG. 2 is exemplary in nature; in practice, any number of computer systems 100 may be coupled/connected using the network 200.

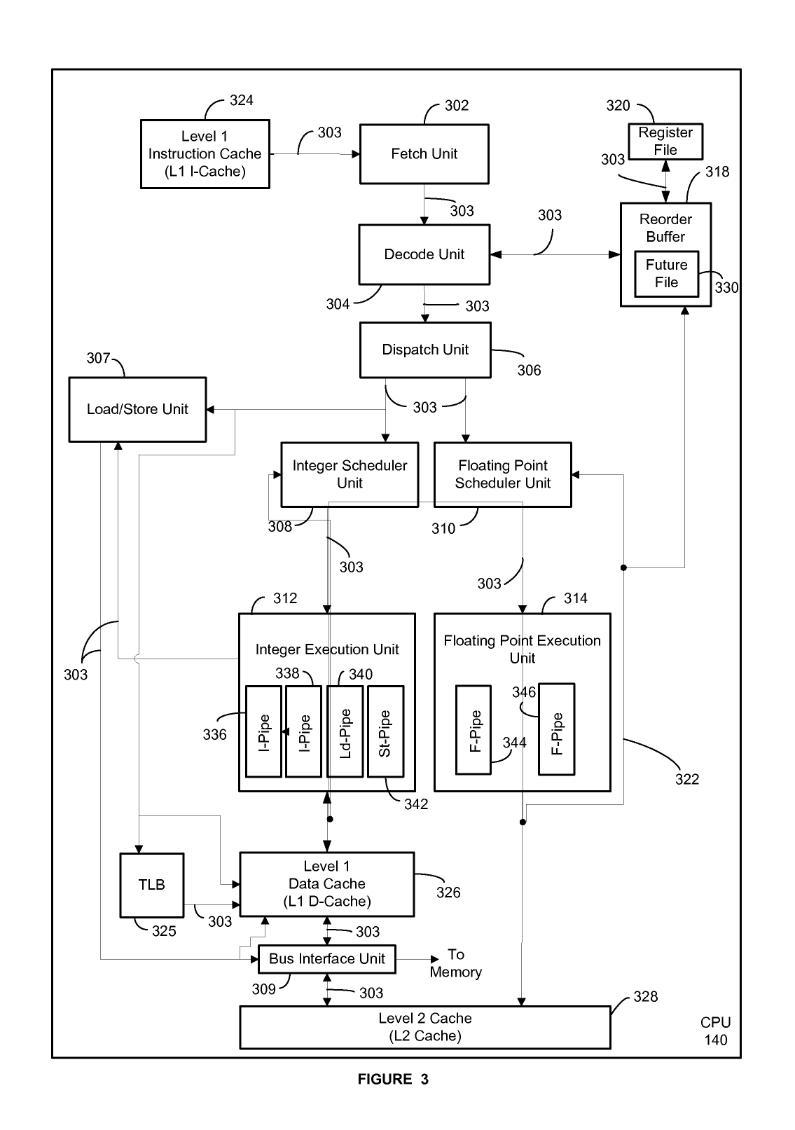

Turning now to FIG. 3, a diagram of an exemplary implementation of the CPU 140, in accordance with an embodiment of the present invention, is illustrated. The CPU 140 includes a fetch unit 302, a decode unit 304, a dispatch unit 306, a load/store unit 307, an integer scheduler unit 308 a floating-point scheduler unit 310, an integer execution unit 312, a floating-point execution unit 314, a reorder buffer 318, and a register file 320. In one or more embodiments, the various components of the CPU 140 may be operatively, electrically and/or physically connected or linked with a bus 303 or more than one bus 303. The CPU 140 may also include a result bus 322, which couples the integer execution unit 312 and the floating-point execution unit 314 with the reorder buffer 318, the integer scheduler unit 308, and the floating-point execution unit 310. Results that are delivered to the result bus 322 by the execution units 312, 314 may be used as operand values for subsequently issued instructions and/or values stored in the reorder buffer 318. The CPU 140 may also include a Level 1 Instruction Cache (LI I-Cache) 324 for storing instructions, a Level 1 Data Cache (L1 D-Cache 326) for storing data and a Level 2 Cache (L2 Cache) 328 for storing data and instructions. As shown, in one embodiment, the L1 D-Cache 326 may be coupled to the integer execution unit 312 via the result bus 322, thereby enabling the integer execution unit 312 to request data from the L1 D-Cache 326. In some cases, the integer execution unit 312 may request data not contained in the L1 D-Cache 326. Where requested data is not located in the L1 D-Cache 326, the requested data may be retrieved from a higher-level cache (such as the L2 cache 328) or memory 155 (shown in FIG. 1) via the bus interface unit 309. In another embodiment, the L1 D-cache 326 may also be coupled to the floating-point execution unit 314. In this case, the integer execution unit 312 and the floating-point execution unit 314 may share a unified L1 D-Cache 326. In another embodiment, the floating-point execution unit 314 may be coupled to its own respective L1 D-Cache. As shown, in one embodiment, the integer execution unit 312 and the floating-point execution unit 314 may be coupled to and share an L2 cache 328. In another embodiment, the integer execution unit 312 and the floating-point execution unit 324 may be each coupled to its own respective L2 cache. In one embodiment, the L2 cache 328 may provide data to the L1 I-Cache 324 and L1 D-Cache 326. In another embodiment, the L2 cache 328 may also provide instruction data to the L1 I-Cache 324. In different embodiments, the L1 I-Cache 324, L1 D-Cache 326, and the L2 Cache 328 may be may be implemented in a fully-associated, set-associative, or direct mapped configuration. In one embodiment, the L2 Cache 328 may be larger than the L1 I-Cache 324 or the L1 D-Cache 326. In alternate embodiments, the L1 I-Cache 324, the L1 D-Cache 326 and/or the L2 cache 328 may be separate from or external to the CPU 140 (e.g. located on the motherboard). It should be noted that embodiments of the present invention are not limited by the sizes and configuration of the L1 I-Cache 324, the L1 D-Cache 326, and the L2 cache 328.

Referring still to FIG. 3, the CPU 140 may support out-of-order instruction execution. Accordingly, the reorder buffer 318 may be used to maintain the original program sequence for register read and write operations, to implement register renaming, and to allow for speculative instruction execution and branch misprediction recovery. The reorder buffer 318 may be implemented in a first-in-first-out (FIFO) configuration in which operations move to the bottom of the reorder buffer 318 as they are validated, making room for new entries at the top of the reorder buffer 318. The reorder buffer 318 may retire an operation once an operation completes execution and any data or control speculation performed on any operations, up to and including that operation in program order, is verified. In the event that any data or control speculation performed on an operation is found to be incorrect (e.g., a branch prediction is found to be incorrect), the results of speculatively-executed instructions along the mispredicted path may be invalidated within the reorder buffer 318. It is noted that a particular instruction is speculatively executed if it is executed prior to instructions that precede the particular instruction in program order.

In one embodiment, the reorder buffer 318 may also include a future file 330. The future file 330 may include a plurality of storage locations. Each storage location may be assigned to an architectural register of the CPU 140. For example, in the x86 architecture, there are eight 32-bit architectural registers (e.g., Extended Accumulator Register (EAX), Extended Base Register (EBX), Extended Count Register (ECX), Extended Data Register (EDX), Extended Base Pointer Register (EBP), Extended Source Index Register (ESI), Extended Destination Index Register (EDI) and Extended Stack Pointer Register (ESP)). Each storage location may be used to store speculative register states (i.e., the most recent value produced for a given architectural register by any instruction). Non-speculative register states may be stored in the register file 320. When register results stored within the future file 330 are no longer speculative, the results may be copied from the future file 330 to the register file 320. The storing of non-speculative instruction results into the register file 320 and freeing the corresponding storage locations within reorder buffer 318 is referred to as retiring the instructions. In the event of a branch mis-prediction or discovery of an incorrect speculatively-executed instruction, the contents of the register file 320 may be copied to the future file 330 to replace any erroneous values created by the execution of these instructions.

Referring still to FIG. 3, the fetch unit 302 may be coupled to the L1 I-cache 324 (or a higher memory subsystem, such as the L2 cache 328 or external memory 155 (shown in FIG. 1)). The fetch unit 302 may fetch instructions from the L1 I-Cache for the CPU 140 to process. The fetch unit 302 may contain a program counter, which holds the address in the L1 I-Cache 324 (or higher memory subsystem) of the next instruction to be executed by the CPU 140. In one embodiment, the instructions fetched from the L1 I-cache 324 may be complex instruction set computing (CISC) instructions selected from a complex instruction set, such as the x86 instruction set implemented by processors conforming to the x86 processor architecture. Once the instruction has been fetched, the instruction may be forwarded to the decode unit 304.

The decode unit 304 may decode the instruction and determine the opcode of the instruction, the source and destination operands for the instruction, and a displacement value (if the instruction is a load or store) specified by the encoding of the instruction. The source and destination operands may be values in registers or in memory locations. A source operand may also be a constant value specified by immediate data specified in the instruction encoding. Values for source operands located in registers may be requested by the decode unit 304 from the reorder buffer 318. The reorder buffer 318 may respond to the request by providing either the value of the register operand or an operand tag corresponding to the register operand for each source operand. The reorder buffer 318 may access the future file 330 to obtain values for register operands. If a register operand value is available within the future file 330, the future file 330 may return the register operand value to the reorder buffer 318. On the other hand, if the register operand value is not available within the future file 330, the future file 330 may return an operand tag corresponding to the register operand value. The reorder buffer 318 may then provide either the operand value (if the value is ready) or the corresponding operand tag (if the value is not ready) for each source register operand to the decode unit 304. The reorder buffer 318 may also provide the decode unit 304 with a result tag associated with the destination operand of the instruction if the destination operand is a value to be stored in a register. In this case, the reorder buffer 318 may also store the result tag within a storage location reserved for the destination register within the future file 330. As instructions (or instructionerations, as will be discussed below) are completed by the execution units 312, 314, each of the execution units 312, 314 may broadcast the result of the instruction and the result tag associated with the result on the result bus 303. When each of the execution units 312, 314 produces the result and drives the result and the associated result tag on the result bus 322, the reorder buffer 318 may determine if the result tag matches any tags stored within. If a match occurs, the reorder buffer 318 may store the result within the storage location allocated to the appropriate register within the future file 330.

After the decode unit 304 decodes the instruction, the decode unit 304 may forward the instruction to the dispatch unit 306. The dispatch unit 306 may determine if an instruction is forwarded to either the integer scheduler unit 308 or the floating-point scheduler unit 310. For example, if an opcode for an instruction indicates that the instruction is an integer-based operation, the dispatch unit 306 may forward the instruction to the integer scheduler unit 308. Conversely, if the opcode indicates that the instruction is a floating-point operation, the dispatch unit 306 may forward the instruction to the floating-point scheduler unit 310.

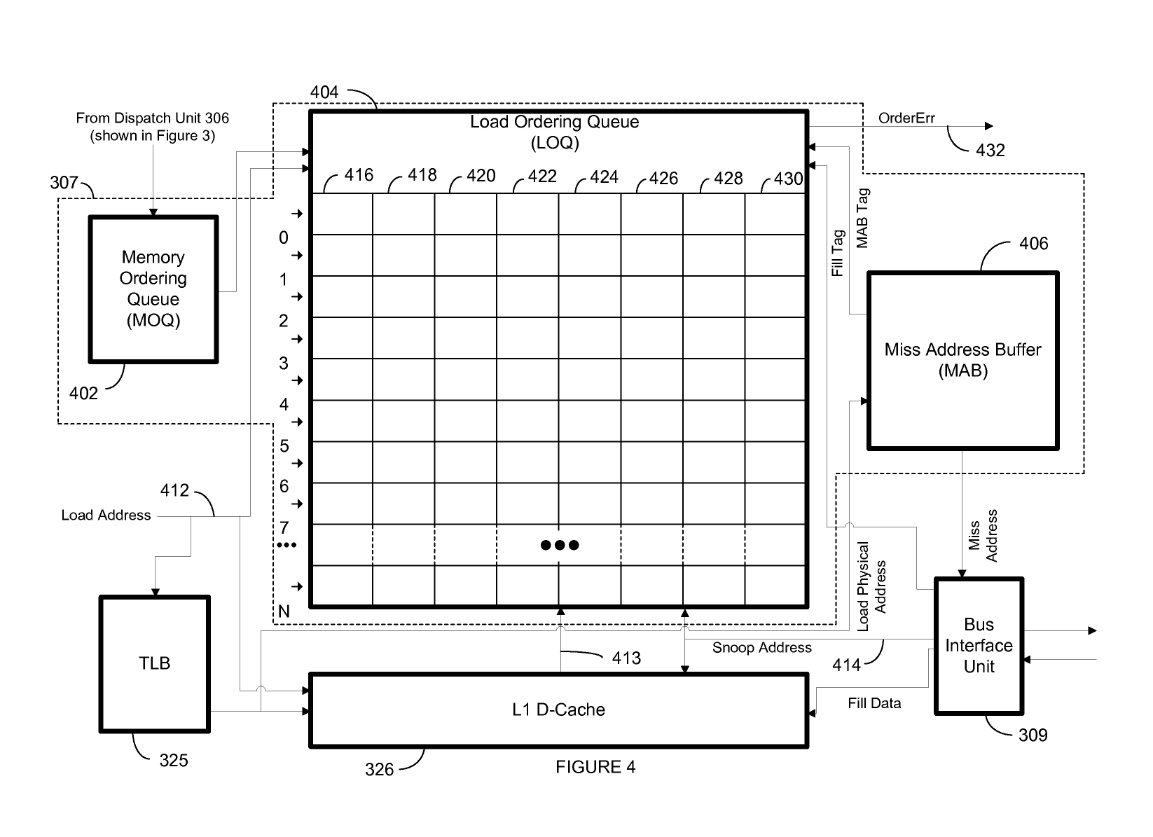

In one embodiment, the dispatch unit 306 may also forward load instructions (“loads”) and store instructions (“stores”) to the load/store unit 307. The load/store unit 307 may store the loads and stores in various queues and buffers (as will be discussed below in reference to FIG. 4) to facilitate in maintaining the order of memory operations by keeping in-flight memory operations (i.e. operations which have completed but have not yet retired) in program order. The load/store unit 307 may also maintain a queue (e.g,. the load ordering queue (LOQ) 404, shown in FIG. 4) that stores out-of-order loads (i.e., a load that executes out-of-order with respect to other loads). The load/store unit 307 may also be configured to receive snoop operations (e.g., stores) from other cores of the main structure 110 (e.g., the GPU 125, the northbridge 145, the southbridge 150, or another CPU 140). In doing so, the load/store unit 307 may be able to detect snoop hits or snoop misses on any of the out-of-order loads. Upon detecting a snoop hit on an out-of-order load, it may be determined that a memory ordering violation has occurred. As a result, an error signal may be asserted, which may cause the CPU 140 to flush the pipeline and re-execute the out-of-order loads stored in the LOQ 404.

Once an instruction is ready for execution, the instruction is forwarded from the appropriate scheduler unit 308, 310 to the appropriate execution unit 312, 314. Instructions from the integer scheduler unit 308 are forwarded to the integer execution unit 312. In one embodiment, integer execution unit 312 includes two integer execution pipelines 336, 338, a load execution pipeline 340 and a store execution pipeline 342, although alternate embodiments may add to or subtract from the set of integer execution pipelines and the load and store execution pipelines. Arithmetic and logical instructions may be forwarded to either one of the two integer execution pipelines 336, 338, where the instructions are executed and the results of the arithmetic or logical operation are broadcast to the reorder buffer 318 and the scheduler units 308, 310 via the result bus 322. Memory instructions, such as loads and stores, may be forwarded, respectively, to the load execution pipeline 340 and store execution pipeline 342, where the address for the load or store is generated. The load execution pipeline 340 and the store execution pipeline 342 may each include an address generation unit (AGU) (not shown), which generates the address for its respective load or store. Each AGU may generate a linear address for its respective load or store. Once the linear address is generated, the L1 D-Cache 326 may be accessed to either write the data for a store or read the data for a load (assuming the load or store hits the cache). If the load or store misses the cache, then the data may be written to or read from the L2 cache 328 or memory 155 (shown in FIG. 1) via the bus interface unit 309. In one embodiment, the L1 D-Cache 326, the L2 cache 328 or the memory 155 may be accessed using a physical address. Therefore, the CPU 140 may also include a translation lookaside buffer (TLB) 325 to translate linear addresses into physical addresses.

Referring still to FIG. 3, instructions from the floating-point scheduler unit 310 are forwarded to the floating-point execution unit 314, which comprises two floating-point execution pipelines 344, 346, although alternate embodiments may add to or subtract from the set of floating-point execution pipelines 344, 346. The first execution pipeline 344 may be used for floating point division, multiplication and single-instruction multiple data (SIMD) permute instructions, while the second execution pipeline 346 may be used for other SIMD scalar instructions. Once the operations from either of the floating-point execution pipelines 344, 346 have completed, the results from the instructions may be written back to the reorder buffer 318, the floating-point scheduling unit 310, and the L2 cache 328 (or memory 155 (shown in FIG. 1)).

Turning now to FIG. 4, a block diagram of the load/store unit 307 coupled with the L1 D-Cache 326 and the TLB 325, in accordance with an embodiment of the present invention, is illustrated. As shown, the load/store unit 307 includes a memory ordering queue (MOQ) 402, a load ordering queue (LOQ) 404, and a miss address buffer (MAB) 406. The MOQ 402 may store loads dispatched from the dispatch unit 306 (shown in FIG. 3) in program order. The LOQ 404 may store loads that are determined to be executing out-of-order with respect to other loads. The MAB 406 may store load addresses for loads that resulted in a cache miss (i.e., miss addresses). The load/store unit 307 may also include other components not shown (e.g., a queue for storing stores and various other load/store handling circuitry).

The load/store unit 307 may receive a load address via a bus 412. The load address may be generated from the AGU (now shown) located in the load pipe 340 of the integer execution unit 312. As mentioned earlier, the load address generated may be a linear address. The load/store unit 307 may also receive a snoop address via a bus 414, which may be coupled to the bus interface unit 309 (also shown in FIG. 3), which may correspond to a snoop operation (e.g., a store) received by the CPU 140 from another core within the main structure 100. In one embodiment, the snoop address may also be a linear address.

As previously mentioned, loads dispatched from the dispatch unit 306 may be stored in the MOQ 402 in program order. The MOQ 402 may be organized as an ordered array of 1 to N storage entries. Each MOQ 402 may be implemented in a FIFO configuration in which loads move to the bottom of the queue, making room for new entries at the top of the queue. New loads are loaded in at the top and shift toward the bottom as new loads are loaded into the MOQ 402. Therefore, newer or “younger” loads are stored toward the top of the queue, while “older” loads are stored toward the bottom of the queue. The loads may remain in the MOQ 402 until they have executed. The operations stored in the MOQ 402 may be used to determine if a load has executed out-of-order with respect to other loads. For example, when a load address is generated for a load, the MOQ 402 may be searched for the corresponding load. Once the load is detected, the MOQ 402 entries below the detected load may be searched for older loads. If older loads are found, then it may be determined that the load is executing out-of-order.

A load may be ready for execution when the load address for the load has been generated. The load address may be transmitted to the load/store unit 307, where it may be determined if the load is executing out-of order. If it is determined that the load is executing out-of-order, the load address of the load is stored in an entry in the LOQ 404, where each entry represents a different load. In one embodiment, the LOQ 404 may store the index portion of the load address. Each entry may also include a plurality of fields (416, 418, 420, 422, 424, 426, 428, and 430) that store information associated with a load. One such field may be the index field 416, which stores the index portion of the load address for the load. Other fields (e.g., “way” field 418, “way” valid field 420, MAB tag field 422, and MAB tag valid field 424) in the LOQ 404 may contain information indicative of whether or not the data for the load is stored in the L1 D-Cache 326 or elsewhere (e.g., the L2 cache 328 or memory 155).

For example, when a load is ready for execution, the load address may be transmitted to the TLB 325 (for embodiments where the load address is a linear address) and the L1 D-Cache 326. The L1 D-Cache 326 may use the linear address to begin the cache lookup process (e.g., by using the index bits of the linear address). The TLB 325 may translate the linear address into a physical address, and may provide the physical address to the L1 D-Cache 326 for tag comparison to detect a cache hit or a cache miss. If a cache hit is detected, the L1 D-Cache 326 may complete the tag comparison and may signal the cache hit or cache miss result to the LOQ 404 via a bus 413. In an embodiment where the L1 D-Cache 326 is a set-associative cache, the L1 D-Cache 326 may instead provide the hitting “way” to the LOQ 404 via the bus 413. The hitting “way” of the L1 D-cache 326 may be stored in the “way” field 418 in the LOQ 404 entry assigned to the load. Upon receiving the “way”, the LOQ 404 may also set an associated valid “way” bit, which may be stored in the “way” valid field 420.

In one embodiment, if a cache miss is detected (i.e., the data is not located in the L1 D1-Cache 326), the data (i.e., fill data) is fetched from the L2 cache 328 or memory 155 using the MAB 406. The MAB 406 may allocate entries that miss addresses for each load that results in a cache miss. The MAB 406 may transmit the miss address to the bus interface unit 309, which fetches fill data from the L2 cache 328 or memory 155, and subsequently stores the fin data into the L1 D-Cache 326. The MAB 406 may also provide to the LOQ 404 a tag identifying the entry within the MAB 404 (a “MAB tag”) for each load that resulted in a cache miss. The MAB tag may be stored in the MAB tag field 422. In another embodiment, if a cache miss is detected, the load may receive data from a store that previously missed the L1 D1-Cache 326 (i.e., store-to-load forwarding). In this case, a MAB tag associated with the store that previously missed in the L1 D1-Cache 326 may be forwarded to the MAB tag field 422. In either case, upon receiving the MAB tag, the LOQ 404 may set an associated MAB tag valid bit, which is stored in the MAB tag valid field 424. The LOQ 404 may use the MAB tag to determine when data has been returned via the bus interface unit 309. For example, when returning data, the bus interface unit 309 may provide a tag (“fill tag”) corresponding to the fill data. The fill tag may be compared with the MAB tags stored in the LOQ 404. If a match occurs, then it is determined that fill data has been returned and stored in the L1 D-Cache 328. In one embodiment, once the fill data is stored in the L1 D-Cache 328, the “way” that the fill data was stored in may be stored in the “way” field 418 of the LOQ 404 entry assigned to the load. Upon storing the “way,” the LOQ 404 may set the associated valid “way” bit stored in the “way” valid field 420 and clear the associated MAB valid bit stored in the MAB valid field 424. In another embodiment, as a power-saving measure, the “way” may instead be stored in the MAB tag field 422. In this case, the “way” is not stored in “way” field 418, the “way” valid bit stored in the “way” valid field 420 is not set, and the MAB valid bit stored in the MAB valid field 424 remains set.

Referring still to FIG. 4, each entry in the LOQ 404 may also include an older load-mapping (OLM) field 426. The OLM field 426 contains a mapping of all the loads older than the current load. In one embodiment, the OLM field 426 may be n bits long, where n represents the depth of the MOQ 402. When an out-of-order load is stored in the LOQ 404, the LOQ 404 searches the MOQ 402 to determine which loads are older than the current load. For example, suppose that the MOQ 402 is a 12-deep queue, and there are three loads (L1, L2, L3) currently in the MOQ 402. Next, suppose that L3's address is generated first, and therefore, is executing out-of-order. As a result, L3 is stored in the LOQ 404, and the LOQ 404 searches the MOQ 402 for older loads. In this case, it will be determined that L1 and L2 are older loads. As a result, bits 0 and 1 of the OLM field may be set, and bits 2 through 11 are not set. When an older load completes, the bit corresponding to that older load is cleared. Once all the OLM bits are cleared, the associated load may be removed from the LOQ 404. For instance, continuing with the example above, suppose L2 executes next. In this case, because L2 has completed out-of-order with respect to L1, L2 is now also stored in the LOQ 404 (with bit 0 of L2's OLM field 426 set). However, because L2 has executed, bit 1 of L3's OLM field is now cleared. Eventually, L1 completes and, as a result, bit 0 of L2's and L3's OLM field 426 are cleared, and L2 and L3 are removed from the LOQ 404. It is noted that L1 is never stored in the LOQ 404 in this example because there are no loads older than it in the MOQ 402.

Each entry in the LOQ 404 may also include an eviction field 428, which stores an eviction bit. The eviction bit may be set if a cache line for a load (which was initially detected as a hit in the L1 D-Cache 328) is evicted to store a different cache line provided in a cache fill operation or a cache replacement algorithm. The LOQ 404 may also clear the “way” valid bit upon setting the eviction bit because the “way” information is no longer correct.

Using the various fields in the LOQ 404 entries, snoop operations to the CPU 140 may be able to detect snoop hits or snoop misses on out-of-order loads. If a snoop hit is detected on an out-of-order load, then a strong memory ordering violation has likely occurred. The snoop hits or snoop misses may be determined without comparing the entire address of the snoop operation (the “snoop address”) to the entire load addresses of the out-of-order loads. In other words, only a portion of the snoop address may be compared to a portion of a given load address. In addition, the snoop hits or snoop misses may be determined using at least one or more matching schemes. One matching scheme that may be used is a “way and index” matching scheme. Another matching scheme that may be used is an index-only matching scheme. The matching scheme used may be determined by the bits set in the various fields of an LOQ 404 entry. For example, the “way and index” matching scheme may be used if the “way” valid bit is set for a given out-of-order load. The index-only matching scheme may be used if the MAB valid bit or the eviction bit is set.

When using the “way and index” matching scheme, the index of each of the out-of-order loads (i.e., the “load index”) having their “way” valid bit set may be compared with the corresponding portion of the snoop address (i.e., the “snoop index”), and the “way” hit in the L1 D-Cache 326 by the snoop operation (i.e., the “snoop way”) is compared to the “way” stored for each of the out-of-order loads having their “way” valid bit set. If both the snoop index and the snoop way match the index and “way” for a given out-of-order load, then the snoop operation is a snoop hit on the given out-of-order load. If no match occurs, then the snoop operation is considered to miss the out-of-order loads.

When using the index-only matching scheme, only the snoop index is compared to each of the out-of-order loads. If the snoop index matches the index of a given out-of-order load (i.e,. the load index), then the snoop operation is a snoop hit on the given out-of-order load. Because the “way” is not taken into consideration when using the index-only matching scheme, the snoop hit may be incorrect. However, taking corrective action for a presumed snoop hit may not affect functionally (only performance). If no match occurs, then the snoop operation is considered to miss the out-of-order loads.

If a snoop hit is detected on an out-of-order load (regardless of the matching scheme used), it is possible that a memory ordering violation has occurred. In one embodiment, upon detecting a possible memory ordering violation, an error bit associated with the out-of-order load may be set. The error bit may be stored in an error field 430 located in each entry of the LOQ 404. When set, the CPU 140 may be notified (via an OrderErr signal 432) to flush the out-of-order load, and each operation subsequent to the out-of-order operation from the pipeline. Repeating the load that had the snoop hit detected may permit the data modified by the snoop operation to be forwarded and new results of the subsequent instructions to be generated. Thus, strong ordering may be maintained.

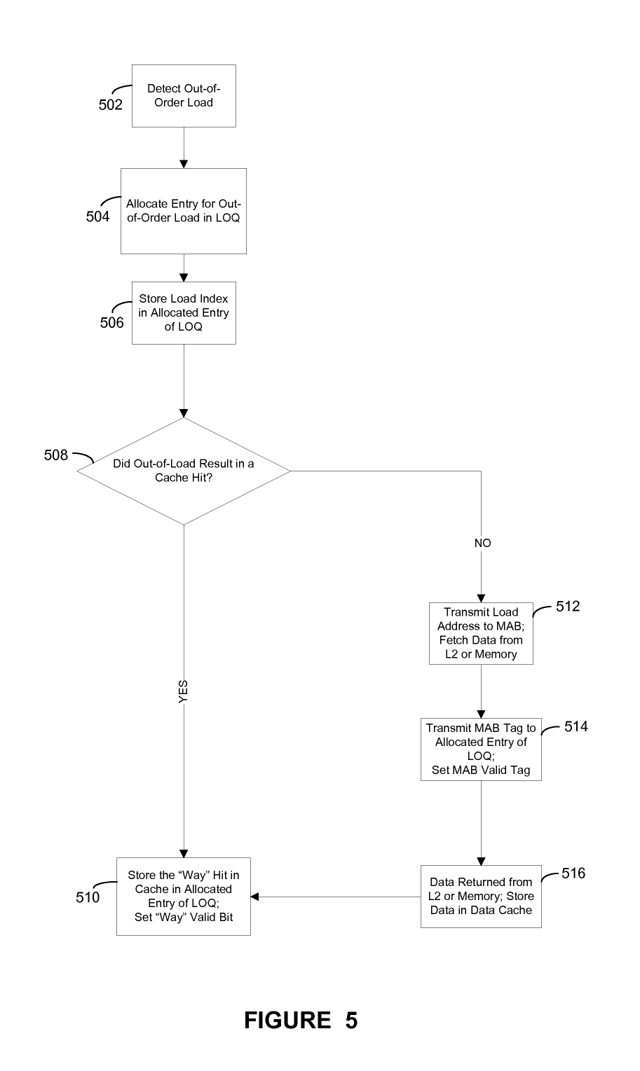

Turning now to FIG. 5, in accordance with one or more embodiments of the invention, a flowchart illustrating operations of the load/store unit 307 during execution of an out-of-order load is shown. The operations being at step 502, where an out-of-order load is detected. At step 504, an entry in the LOQ 404 is allocated for the out-of-order load. At step 506, the load index for the out-of-order load is stored in the index field 416 of the allocated entry. At step 508, it is determined if the out-of-order load resulted in a cache hit in the L1 D-Cache 326. If the out-of-order load resulted in a cache hit, at step 510, the “way” hit in the L1 D-Cache 326 is stored in the “way” field 418 of the allocated entry. The “way” valid bit stored in the “way” valid field 320 of the allocated entry is also set. If the out-of-order load resulted in a cache miss, at step 512, the address of the out-of-order load is transmitted to the MAB 406, which then transmits the address to the bus interface unit 309 to fetch the data from the L2 cache 328 or memory 155. Upon receiving the address, at step 514, the MAB 406 transmits a MAB tag to the LOQ 404, and the LOQ 404 stores the MAB tag in the MAB tag field 422 in the allocated entry. The MAB tag valid bit stored in the MAB tag valid field 424 of the allocated entry is also set. At step 516, the data is returned from the L2 cache 328 or memory 155, and subsequently stored in the L1 D-Cache 326. At step 510, the “way” that the data was stored is stored in the “way” field 418 of the allocated entry for the out-of-order operation, the “way” valid bit stored in the “way” valid field 420 of the allocated entry is set, and the MAB valid bit 424 is cleared.

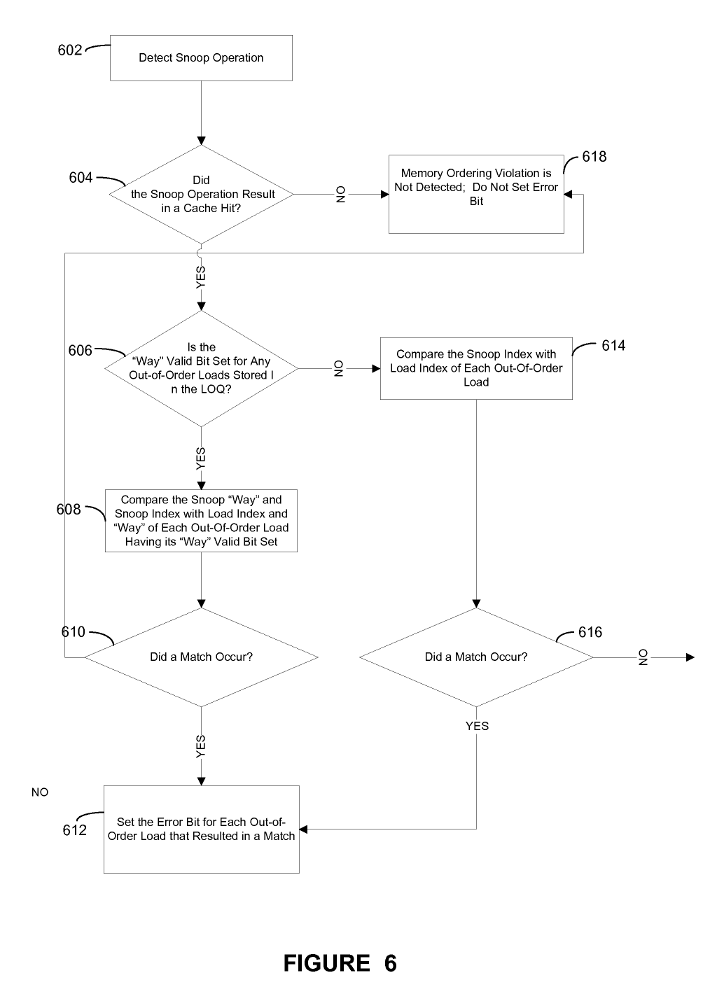

Turning now to FIG. 6, in accordance with one or more embodiments of the invention, a flowchart illustrating operations of the load/store unit 307 during execution of a snoop operation is shown. The operations begin at step 602, where a snoop operation is detected. At step 604, it is determined if the snoop operation hits the L1 D-Cache 326. If the snoop operation does not hit the cache, then at step 618 it is determined that no memory ordering violation has been detected, and therefore, the error bit is not set. On the other hand, if the snoop does hit the cache, then at step 606, it is determined if a “way” valid bit is set for any of the out-of-order loads stored in the LOQ 404. If a “way” valid bit is set, then at step 608, the snoop “way” and snoop index is compared to the load index and “way” of each of the out-of-order loads having its “way” valid bit set. At step 610, it is determined if the comparison has resulted in a match. If a match occurs, at step 612, the error bit for each of the out-of-order loads that resulted in a match is set. If no match occurs, then at step 618 it is determined that no memory ordering violation has been detected, and therefore, the error bit is not set.

Returning to step 606, if it is determined that no out-of-order loads have its “way” bit set, then at step 614, the snoop index is compared to the load index of each out-of-order loads in the LOQ 404. At step 616 it is determined if the comparison has resulted in a match. If a match occurs, then at step 612, the error bit for each of the out-of-order loads that resulted in a match is set. If no match occurs, then at step 618 it is determined that no memory ordering violation has been detected, and therefore, the error bit is not set.

It is also contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units 160, RAMs 130 & 155, compact discs, DVDs, solid state storage and the like). In one embodiment, the GDSII data (or other similar data) may be adapted to configure a manufacturing facility (e.g,. through the use of mask works) to create devices capable of embodying various aspects of the instant invention. In other words, in various embodiments, this GDSII data (or other similar data) may be programmed into a computer 100, processor 125/140 or controller, which may then control, in whole or part, the operation of a semiconductor manufacturing facility (or fab) to create semiconductor products and devices. For example, in one embodiment, silicon wafers containing 10T bitcells 500, 10T bitcell arrays 420 and/or array banks 410 may be created using the GDSII data (or other similar data).

It should also be noted that while various embodiments may be described in terms of memory storage for graphics processing, it is contemplated that the embodiments described herein may have a wide range of applicability, not just for graphics processes, as would be apparent to one of skill in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope and spirit of the claimed invention.

Accordingly, the protection sought herein is as set forth in the claims below.

What is claimed:

1. A method comprising:
storing information associated with a first load operation in a load queue, the first load operation being executed out-of-order with respect to one or more load operations;
detecting a snoop hit on the first load operation; and
re-executing the first load operation in response to detecting the snoop hit.

2. The method of claim 1, wherein the storing information associated with a first load operation in a load queue further comprises:
determining if the first load operation resulted in a cache hit of a data cache; and
storing one of a first data associated with the first load operation and a second data associated with the first load operation in the load queue in response to determining that the first load operation resulted in a cache hit, or the first data associated with the first load operation in the load queue in response to determining that the first load operation did not result in a cache hit.

3. The method of claim 2, wherein the first data is an index portion of an address of the first load operation.

4. The method of claim 2, wherein the second data is a way hit in the data cache.

5. The method of claim 2, wherein detecting the snoop hit comprises:
comparing a first portion and a second portion of information associated with the snoop operation with the first data and the second data, respectively, in response to determining that the first load operation resulted in a cache hit; and
comparing the first portion of information associated with the snoop operation with the first data in response to determining that the first load operation resulted in a cache miss.

6. The method of claim 1, further comprising:
removing the information associated with the first load operation from the load queue in response to determining that the one or more second load operations has completed.

7. The method of claim 1, further comprising mapping the one or more second load operations.

8. The method of claim 1, further comprising mapping the one or more second load operations with an indication that each of the one or more second load operations has completed.

9. An apparatus comprising:
a load queue for storing information associated with a first load operation, the first load operation being executed out-of-order with respect to one or more second load operations; and
a processor configured to:
store the information associated with the first load operation in the load queue;
detect a snoop hit on the first load operation; and
re-execute the first load operation in response to detecting the snoop hit.

10. The apparatus of claim 9, wherein the processor is configured to store information associated with a first load operation in a load queue by:
determining if the first load operation resulted in a cache hit of a data cache; and
storing one of a first data associated with the first load operation and a second data associated with the first load operation in the load queue in response to determining that the first load operation resulted in a cache hit, or the first data associated with the first load operation in the load queue in response to determining that the first load operation did not result in a cache hit.

11. The apparatus of claim 10, wherein the first data is an index portion of an address of the first load operation.

12. The apparatus of claim 10, wherein the second data is a way hit in the data cache.

13. The apparatus of claim 10, wherein the processor is configured to detect a snoop hit by:
comparing a first portion and a second portion of information associated with the snoop operation with the first data and the second data, respectively, in response to determining that the first load operation resulted in a cache hit; and
comparing the first portion of information associated with the snoop operation with the first data in response to determining that the first load operation resulted in a cache miss.

14. The apparatus of claim 9, wherein the processor is further configured to:
remove the information associated with the first load operation from the load queue in response to determining that the one or more second load operations has completed.

15. The apparatus of claim 9, wherein the processor is further configured to map the one or more second load operations.

16. The apparatus of claim 9, wherein the processor is further configured to map the one or more second load operations with an indication that each of the one or more second load operations has completed.

17. The apparatus of claim 9, further comprising:
a storage element communicatively coupled to the processor;
an output element communicatively coupled to the processor; and
an input device communicatively coupled to the processor.

18. The apparatus of claim 9, wherein the apparatus is at least one of a computer motherboard, a system-on-a-chip, or a circuit board.

19. A computer readable storage medium encoded with data that, when implemented in a manufacturing facility, adapts the manufacturing facility to create an apparatus that comprises:
a load queue for storing information associated with a first load operation, the first load operation being executed out-of-order with respect to one or more second load operations; and
a processor configured to:
store the information associated with the first load operation in the load queue;
detect a snoop hit on the first load operation; and
re-execute the first load operation in response to detecting the snoop hit.

20. The computer readable storage medium of claim 19, wherein the processor is configured to store information associated with a first load operation in a load queue by:
determining if the first load operation resulted in a cache hit of a data cache; and
storing one of a first data associated with the first load operation and a second data associated with the first load operation in the load queue in response to determining that the first load operation resulted in a cache hit, or the first data associated with the first load operation in the load queue in response to determining that the first load operation did not result in a cache hit.

21. The computer readable storage medium of claim 20, wherein the first data is an index portion of an address of the first load operation.

22. The computer readable storage medium of claim 20, wherein the second data is a way hit in the data cache.

23. The computer readable storage medium of claim 20, wherein the processor is configured to detect a snoop hit by:
comparing a first portion and a second portion of information associated with the snoop operation with the first data and the second data, respectively, in response to determining that the first load operation resulted in a cache hit; and
comparing the first portion of information associated with the snoop operation with the first data in response to determining that the first load operation resulted in a cache miss.

24. The computer readable storage medium of claim 19, wherein the processor is further configured to:
remove the information associated with the first load operation from the load queue in response to determining that the one or more second load operations has completed.

25. The computer readable storage medium of claim 19, wherein the processor is further configured to map the one or more second load operations.

26. The computer readable storage medium of claim 19, wherein the processor is further configured to map the one or more second load operations with an indication that each of the one or more second load operations has completed.

27. The computer readable storage medium of claim 19, wherein the apparatus further comprises:
a storage element communicatively coupled to the processor;
an output element communicatively coupled to the processor; and
an input device communicatively coupled to the processor.

28. The computer readable storage medium of claim 19, wherein the apparatus is at least one of a computer motherboard, a system-on-a-chip, or a circuit board.
